(19) United States
(12) Patent Application Publication
(10) Pub. No.: US 2004/0249438 A1
(43) Pub. Date: Dec. 9, 2004

(54) Endovascular prosthesis coated with a functionalised dextran derivative

(76) Inventors: Oliver Lefranc, Lormaison (FR); Thierry Avramoglou, Groslay (FR); Jacqueline Jozefonvicz, Lamorlaye (FR); Thierry Darnis, Frans (FR); Michel Therin, Lyon (FR)

Correspondence Address: OLIFF & BERRIDGE, PLC, P.O. BOX 19928, ALEXANDRIA, VA, 22320, US

(21) Appl. No.: 10/483,321

(22) PCT Filed: Jul. 29, 2002
(86) PCT No.: PCT/FR02/02722

(30) Foreign Application Priority Data
Jul. 27, 2001 (FR) 01 10199
Oct. 19, 2001 (FR) 01 13540

(51) Int. Cl. B05D 3/00

(52) U.S. Cl. 623/1.15; 427/2.25; 623/901

(57) ABSTRACT

The invention concerns a metal object for medical or surgical use, such as a prosthesis, for example an endovascular prosthesis (called stent) for percutaneous transluminal coronary angioplasty, comprising a metal substrate whereof the surface is coated partly at least with a polysaccharide compound. The invention is characterised in that the polysaccharide compound is covalently bound, via a plurality of grafting arms, comprising each at least a silane unit, bound on one side to the metal substrate by an —O— metal bond, and on the other side, directly or indirectly, by a covalent —NH— bond, with the polysaccharide compound.

The present invention relates to the field of metallic endoprostheses and more particularly to the stents used in the treatment of stenotic diseases.

The use of stents has increased considerably in the last five years and now represents the vast majority of percutaneous transluminal coronary angioplasties.

Before stents were used, three quarters or more of patients who had undergone a percutaneous transluminal coronary angioplasty suffered restenosis, necessitating repeated intervention.

The use of stents has reduced this percentage considerably. Nevertheless, there is still a high rate of restenosis (about 30%) despite the use of these implants.

To make these metallic endoprostheses more effective and better tolerated, their surface can be modified by chemical or radioactive treatments, and/or coated with substances of biological origin (heparin, phosphorylcholine, DNA), with polymers (silicones, polyurethanes, expanded polytetrafluoroethylene) or with ceramics (TiO₂, C . . . ). Other endoprostheses consist of carbon and even of biodegradable materials.

The various surface modifications can in certain cases improve the behavior of stents in vivo but so far have not been able to prevent complications such as restenosis. Furthermore, some of these modifications can lead to substantial degradation of the mechanical properties of the stent to which they are applied.

Metallic prostheses are known from EP-B-716836, including endoprostheses for angioplasty which are coated with a polymer film that enables pharmaceutical active principles to be delivered in situ, by biodegradation of the polymer.

The immobilization of acrylic polymers on the surface of a metallic endoprosthesis, by deposition by electropolymerization, which would then permit the fixation and distribution of active principles, is known from FR-A-2785812. No example of fixation of an active principle and of distribution while conserving the biological properties of the active principle is mentioned in that patent.

In these two patents, in addition to the fact that the pharmaceutical active principles would necessarily be released in order to have a biological activity, the polymers permitting their fixation are deposited in layers on metallic surfaces, and, as explained earlier, these layers may present a risk of delamination. Moreover, owing to the biodegradability of the polymer and the distribution of the active principle, the biological effects are inevitably limited in time.

We may also cite, from WO-A-9746590, the immobilization of bioactive substances permitting the modification of the properties of polymers on the surface of which this immobilization is effected, for example to endow them with antithrombotic properties and in addition make their surface hydrophilic; these polymers are used for the manufacture of vascular prostheses, for example in expanded PTFE.

Functionalized dextran derivatives corresponding to the general formula DMCₐB_{b}Su_{c}S_{d} in which:

D represents a polysaccharide chain, consisting of arrangements of α-D-glucopyranose units joined together by α(1-6) bonds,

MC represents methylcarboxylate groups,

B represents carboxymethylbenzylamide groups,

Su represents sulfate groups,

S represents sulfonate groups, and

a, b, c and d represent the degree of substitution (ds), expressed relative to the number of free hydroxyl functions in one glucoside unit of the dextran, respectively in groupings MC, B, Su and S, a being equal to 0 or ≧0.2, b being equal to 0 or ≧0.1, c being equal to 0 or ≧0.1 and d being equal to 0 or ≦0.15, provided that when d=0, a and/or b are # 0, are known from WO 99/29734 or from the article by D. Logeart-Avramoglou and J. Jozefonvicz published in J. Biomed. Mater. Res. (Appl. Biomater) 48, 578-590, 1999.

We also know, from EP-A-146455, dextran derivatives containing, randomly:

at least approx. 35% of units B made up of oside units A substituted by radicals possessing a carboxyl function corresponding to the structure —O—(CH₂)ₙ—R—COO⁻ in which R represents a single bond or a group —CO—NH—(CH₂)_{n′}⁻, n being a number between 1 and 10 and n′ being between 1 and 7.

at least approx. 3% of units D, i.e. of oside units A substituted by a chain containing a group with the structure:

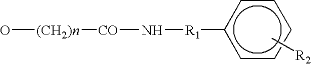

in which n is defined above, R₂ represents an anion of a physiologically acceptable inorganic or organic salt, and R₁ represents a single bond, a group —CH₂— or a group:

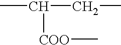

possibly, unsubstituted oside units A and/or units C consisting of units A substituted by radicals with the following structure, in which R₁ and n are as defined above:

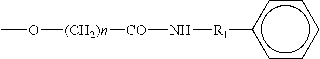

We also know, from EP-A-0428182, dextran derivatives with molecular weight greater than about 5000 g/mol, that have strong anti-complement activity and low anti-coagulant activity, which contain units A and C and at least 35% of units B, these units being as defined above in patent EP-A-0146455.

The presence of functionalized dextran derivatives on the surface of the endoprosthesis makes it possible to develop, on the surface of the latter, specific interactions with the biological environment in which it is implanted; notably we observe inhibition of the proliferation of human smooth muscle cells and proliferation of the endothelial cells in contact with the endoprosthesis, a process that promotes integration of the endoprosthesis in the biological environment.

Furthermore, depending on their degrees of substitution with different functionalized groups, the functionalized dextran derivatives and the functionalized polysaccharides described above can present anti-complement activity and can act as a substitute for blood plasma, can display a modulating effect on proliferation of smooth muscle and endothelial cells or anticoagulant properties or antiplatelet action.

The aim of the present invention is therefore to endow a metallic substrate, that can be used as an endoprosthesis, for example a stent, with biological properties of interest, taking into account the application or indication of said prosthesis, in a manner that is completely integrated with the metallic substrate and permanently, i.e. without altering the intrinsic mechanical properties of said substrate on the one hand, and permanently fixing, on said substrate, the agents or active compounds adopted because they exhibit the aforementioned biological properties, on the other hand.

A first object of the present invention therefore consists of a method of coating and binding the surface of a metallic substrate with a layer of a polysaccharide compound, characterized in that, on the basis of the metallic substrate:

(a) we have an agent for chemical modification of the surface of the metallic substrate, for example in liquid form;

(b) we have an agent for intermediate covering, comprising a silane compound, in solution for example, containing two reactive residues, one with the metallic substrate, and the other, directly or indirectly, with the polysaccharide compound;

(c) we have a coating agent, containing, in solution for example, the polysaccharide compound;

and the following operations are carried out:

(1) the surface of the metallic substrate is brought into contact with the agent for chemical modification, to obtain a chemically modified surface;

(2) the chemically modified surface is brought into contact with the intermediate covering agent, to obtain a surface coated with an intermediate layer comprising the silane compound, bound covalently to the metallic substrate;

(3) the intermediate layer is brought into contact with the coating agent, to coat said intermediate layer with a coating comprising the polysaccharide compound bound covalently, directly or indirectly, to the silane compound.

According to the invention, step (3) of bringing the intermediate layer into contact with the coating agent can be repeated to improve the thickness of the coating layer comprising the polysaccharide compound bound covalently, directly or indirectly, to the silane compound.

According to the invention, the metallic substrate obtained in step (2) of the method can be isolated, the method according to the invention thus consists of a method of coating and binding the surface of a metallic substrate with a layer of an intermediate covering agent comprising a silane compound, characterized in that, on the basis of the metallic substrate:

(a) we have an agent for chemical modification of the surface of the metallic substrate, for example in liquid form;

(b) we have an intermediate covering agent, containing a silane compound, having at least one residue that can react with the metallic substrate,

and the following operations are carried out:

(1) the surface of the metallic substrate is brought into contact with the agent for chemical modification, to obtain a chemically modified surface;

(2) the chemically modified surface is brought into contact with the intermediate covering agent, to obtain a surface that is coated with a layer containing the silane compound, bound covalently to the metallic substrate.

Another object of the present invention is a metallic object for medical or surgical use, of the prosthesis type, for example an endovascular prosthesis (called a “stent”) for percutaneous transluminal coronary angioplasty, comprising a metallic substrate whose surface is coated at least partly with a polysaccharide compound, characterized in that the polysaccharide compound is bound covalently to the metallic substrate, via linkages, each comprising at least one silane unit, bound on the one hand to the metallic substrate by a metal-O— bond, and on the other hand, directly or indirectly, by a covalent bond —NH—, with the polysaccharide compound.

Another object of the invention is a metallic object for medical or surgical use, of the prosthesis type, for example an endovascular prosthesis (called a “stent”) for percutaneous transluminal coronary angioplasty, comprising a metallic substrate whose surface is coated at least partly with a covering agent containing a silane compound, characterized in that the silane compound is bound to the metallic substrate by a metal-O— bond.

According to the invention, the polysaccharide compounds lend themselves well to grafting on a metallic substrate, if an at least bifunctionalized silane compound is used, and the intrinsic biological properties of the polysaccharide compounds are not altered by the grafting.

Thus, the invention makes it possible to obtain a metallic object for medical or surgical use, of the prosthesis type, for example an endovascular prosthesis (called a “stent”) for percutaneous transluminal coronary angioplasty, which offers the advantage of preserving all its mechanical properties, which triggers a favorable biological response or, at least, does not trigger an unfavorable biological response, in the recipient and therefore limits restenosis.

According to the invention, the method makes it possible to conserve the biological properties of the polysaccharide compound employed by said method and the polysaccharide compound conserves its intrinsic biological properties after deposition.

Intrinsic biological properties are to be understood as the aforementioned biological activities and notably anti-complement activity and activity as blood plasma substitute, modulating activity on proliferation of smooth muscle and endothelial cells, or anticoagulant properties or antiplatelet action.

The objects or the endoprostheses submitted to the method according to the invention also display the characteristic that they do not lead to the spreading of toxic products in the organism.

The non-toxicity of the spread of toxic products in the organism is verified by the test recommended in international standard ISO 10 993-5, relating to the biological evaluation of medical devices.

A metallic substrate according to the invention is a support, whose surface is intended to receive the coating according to the invention, made of metal or whose surface is coated with a metal or an alloy such as stainless steels, alloys based on chromium and cobalt or even superalloys.

Metal, according to the invention, means any material consisting of a simple substance that is a good conductor of heat and electricity, having a high reflectivity in the polished state, and giving oxides that react with water to give bases, such as iron, cobalt and chromium.

“Alloy” means any homogeneous metallic product obtained by combining several metals with a clear preponderance of one of them, so as to endow the latter with particular characteristics.

“Silane compound” means organic compounds selected from the derivatives of silanes having the general formula SiₙH₂ₙ₊₂, in which one or more hydrogen atoms have been substituted by classical organic functions such as alkyl groups, alkoxy groups, amines or other organic functions.

“Derivative of a silane containing one or more reactive functions” means a compound containing one or more amine groups or derivatives of amines that are able to react with the hydroxyl groups of the oside compounds, and have one or more hydroxyl or alkoxy groups capable of reacting, either directly, or after hydrolysis with the metal making up the metallic substrate, for example compounds selected from the group comprising aminopropylsilanes and aminobutylsilanes.

Polysaccharide compound according to the invention means any polymer, natural or synthetic, containing a polymer chain consisting of a multiplicity of oside units, namely any polysaccharide, unmodified and/or unfunctionalized, or any functionalized polysaccharide derivative.

“Functionalized polysaccharide compound” means polysaccharide derivatives containing oside units containing hydroxyl functions substituted by groups such as, for example, methylcarboxylate groups, carboxymethylbenzylamide groups, sulfate groups, sulfonate groups, or whose hydroxyl functions have been substituted by chains containing carboxyl functions, amide functions, or benzyl groups, alone or in combination.

More particularly the polysaccharide compounds will be selected from the compounds of general formula DMCₐB_{b}Su_{c}S_{d} in which:

D represents a polysaccharide chain, consisting of arrangements of α-D-glucopyranose units joined together by α(1-6) bonds,

MC represents methylcarboxylate groups,

B represents carboxymethylbenzylamide groups,

Su represents sulfate groups,

S represents sulfonate groups, and

a, b, c and d represent the degree of substitution (ds), expressed relative to the number of free hydroxyl functions in one glucoside unit of the dextran, respectively in groupings MC, B, Su and S, a being equal to 0 or ≧0.2, b being equal to 0 or ≧0.1, c being equal to 0 or ≧0.1 and d being equal to 0 or ≦0.15, provided that when d=0, a and/or b are ≠0.

Among these functionalized dextran derivatives, we can more particularly use those that are selected from the group comprising:

Functionalized dextrans in which a≧0.7, 0.15≦b≦0.3, 0≦c≦0.15 and d=0 or ≦0.1 and whose weight-average molecular weight is between 5000 and 200 000 g/mol,

Functionalized dextrans in which 0.4≦a≦0.8, 0.3≦b≦0.8, 0.1≦c≦0.9 and d=0 or ≦0.1 and whose weight-average molecular weight is between 5000 and 200 000 g/mol,

Functionalized dextrans in which a≧0.5, 0.3≦b≦0.5, c=0 or ≦0.1 and d=0 or ≦0.1 and whose weight-average molecular weight is between 5000 and 200 000 g/mol.

In another embodiment the polysaccharide compounds can be selected from derivatives of dextrans that contain, randomly:

at least approx. 35% of units B consisting of oside units A substituted by radicals possessing a carboxyl function corresponding to the structure —O—(CH₂)ₙ—R—COO— in which R represents a single bond or a group —CO—NH—(CH₂)_{n′}⁻, n being a number between 1 and 10 and n′ being between 1 and 7.

at least approx. 3% of units D, i.e. of oside units A substituted by a chain containing a group with the structure:

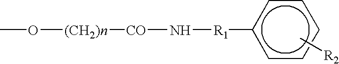

in which n is defined above, R₂ represents an anion of a physiologically acceptable inorganic or organic salt, and R₁ represents a single bond, a group —CH₂— or a group:

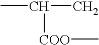

possibly, unsubstituted oside units A and/or units C consisting of units A substituted by radicals with the following structure, in which R₁ and n are as defined above:

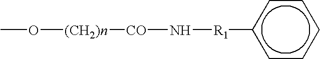

In another embodiment the polysaccharide compounds can be selected from dextran derivatives possessing a molecular weight above about 5000 g/mol, consisting randomly of units A, B and C, the units A being oside units of dextrans, the units B and C being as defined above, which comprise units A and C and at least 35% of units B.

In another embodiment the polyose chain of the polysaccharide compound is that of a polysaccharide selected from the group comprising starch, glycogen, celluloses, dextrans, poly-β-1,3-glucans, poly-β-1,6-glucans, pullulans, chitin, chitosan, arabans, xylans, fucans, and pectins, when the polyose chain of the polysaccharide compound is that of a dextran, it contains a multiplicity of α-D-glucopyranose units joined together by α(1-6) bonds.

In another embodiment the polysaccharide compound is a natural or synthetic, unmodified, in particular unfunctionalized, polysaccharide.

In the method according to the invention the chemically modified surface is cleaned before being brought into contact with the intermediate covering agent, for example with a solution of acetone, or alcohol, and/or of surfactants.

In the method according to the invention the metallic substrate whose surface is coated with the intermediate covering agent is annealed before it is brought into contact with the coating agent, said annealing being carried out at a temperature between 80 and 140° C. approximately, and/or for a time between 1 and 30 minutes approximately.

This annealing causes reversal of the molecule of silane derivative, so that it has a free amine function that is able to react with compounds bearing hydroxyl groups.

For example, this reversal can be illustrated for the molecule of 3-aminopropyltriethoxysilane (γ-APS) as follows:

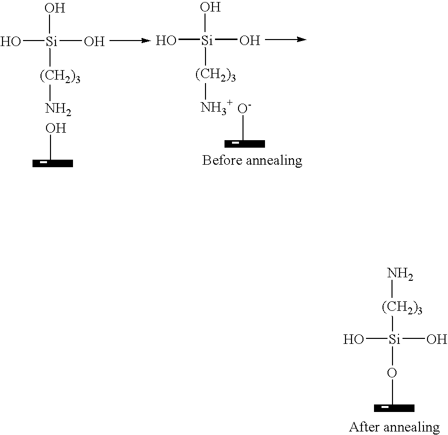

In the method according to the invention the coated surfaces can be washed, notably the coated surface of the intermediate layer is washed, before being brought into contact with the coating agent, and the surface coated with the polysaccharide compound is washed.

In the method according to the invention, operation (1) and/or (2) is carried out in the liquid or the vapor phase and when operation (2) is carried out in the liquid phase, it is carried out at a pH between 2 and 9, and/or at a temperature between 25 and 120° C. approximately, and/or for a time between 1 and 120 minutes approximately.

When operation (2) is carried out in the vapor phase it is carried out at a temperature above 120° C. and at a pressure greater than 4 mbar. When operation (2) is carried out in this way in the vapor phase, the molecule of silane derivative has a free amine function that is able to react with compounds bearing hydroxyl groups to form a covalent bond, the annealing step is therefore immediate and follows grafting, and will not necessitate an additional process step.

The agent for chemical modification of the surface of the metallic substrate, in liquid form, includes at least one strong inorganic acid, for example sulfuric, hydrochloric or nitric acid in a proportion between 5 and 100% (v/v), and at least one chromium oxide in a proportion between 1 and 40% (w/v); the pH of said agent for chemical modification is preferably between 1 and 6.

The chromium oxide has an average molecular weight between 50 and 500 g/mol, and is, for example, selected from the group comprising potassium dichromates and chromium(IV) oxides.

The intermediate covering agent, in the liquid state, contains at most 50%, for example between 1 and 30% (v/v) of the silane compound.

The silane compound has an average molecular weight between 50 and 500 g/mol, and is selected from the group comprising aminopropylsilanes and aminobutylsilanes.

The coating agent, in the liquid state, contains between 1 and 20% (w/v) of the polysaccharide compound, in solution, it contains an unmodified or unfunctionalized polysaccharide, for example a dextran, and/or a functionalized polysaccharide derivative that can be obtained from a polysaccharide, for example a dextran.

When the polysaccharide is a dextran, its average molecular weight is between 20 000 and 1 000 000 g/mol, for example its molecular weight is equal to 40 000 or 70 000, or 460 000 g/mol.

The coating agent contains at least one coupling agent, selected for example from the group comprising bio-sulfo (succinimide-suberate), abbreviated to BS3, dimethyladipimidate, abbreviated to DMA, epoxirane, bis-epoxirane, succinimides, epichlorohydrin, carbodiimides, for example 1-ethyl-3-3-(dimethylaminopropyl)-carbodiimide, abbreviated to EDAC or EDC, or N-hydroxysuccinimide, abbreviated to NHS. Preferentially, the coupling agent is present, in the coating agent, at the rate of 20 to 50 mol per 100 mol of oside unit of the polysaccharide chain.

The coating agent can contain an additional polysaccharide, natural or synthetic, substituted by carboxylate and/or sulfate functions, said additional polysaccharide being different from said functionalized polysaccharide derivative.

The present invention also relates to the coated metallic substrate that can be obtained by the method described above and an endovascular prosthesis, of the stent type, comprising said coated metallic substrate, the material of which it is constituted being an alloy, for example a stainless steel, or a superalloy, for example Phynox.

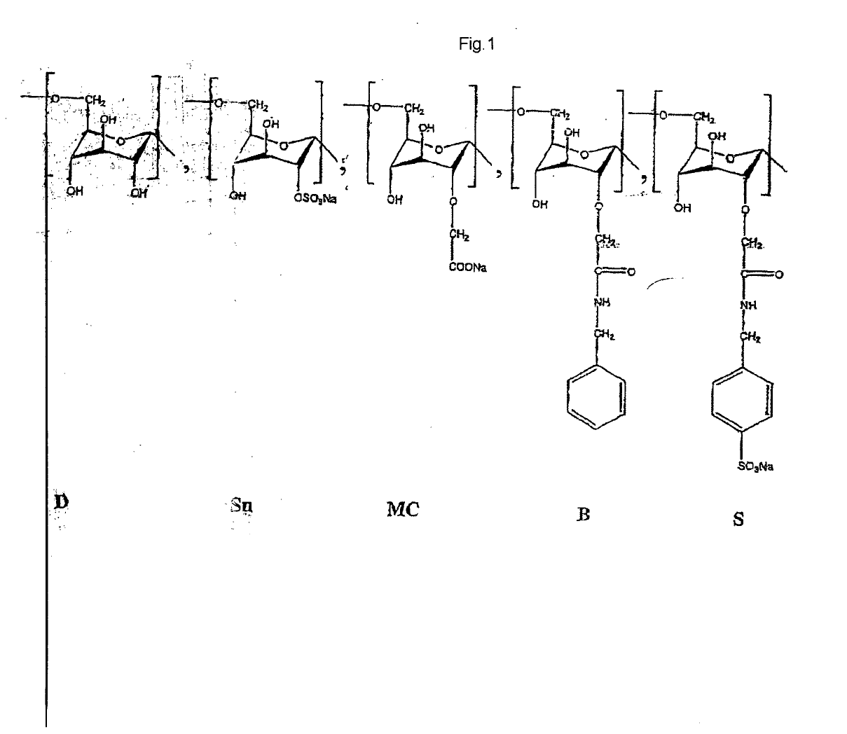

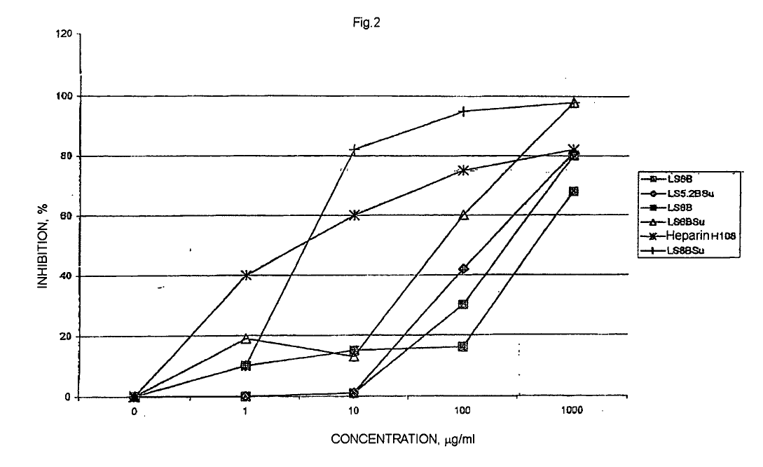

Various objects of the invention are illustrated in the examples of application of the method and in FIGS. 1 to 2 described below:

FIG. 1 is a schematic representation of the structure of a functionalized dextran derivative substituted by various chemical groups MC, B, Su and S fixed on the glucoside units D; as an example, the position of the substituent on the various carbons of the glucoside units is shown on carbon 2;

FIG. 2 shows the curves of inhibition of the proliferation of smooth muscle cells obtained from the rat aorta, after 5 days of incubation, in relation to different functionalized dextran derivatives.

### EXAMPLE 1

Preparation of models for endovascular prostheses in stainless steel according to the present invention, cleaning, oxidation and amination of the surface.

1) Support, Treatment Solutions and Silane Derivatives Used

The support used consists of polished pins of stainless steel 316L with diameter of 8 mm and thickness of 3 mm supplied by the company Sofradim.

These pins serve as a model for the endovascular prostheses themselves in stainless steel 316L.

Stainless steel 316L is a type 18/12 (chromium/nickel content) austenitic steel, with CFC structure, complying with European standards NF S 90 401, NF S 90 402, NF S 90 403 and NF S 94 051.

The cleaning solutions are solutions of acetone and of hot ethanol.

The oxidizing solution is a sulfochromic mixture.

The silane compound is γ-APS (3-aminopropyl)triethoxysilane. This compound attaches itself to the hydroxyl functions of the surface and makes it possible to obtain the exposed amine functions.

2) Protocol

The pins of stainless steel 316L are sonicated in acetone for 10 minutes then placed for 10 minutes in an ethanol solution at 70° C.

This step permits elimination of the surface-active elements for the cleaning.

A solution of γ-APS at 10% (v/v) in 95° ethanol is prepared and is stirred for 1 hour in order to hydrolyze the ethoxy functions and permit grafting on hydroxyl functions.

The oxidation solution is a sulfochromic solution at 2.7% (w/v) of potassium dichromate in 80% sulfuric acid.

At the same time, the cleaned steel pins are placed in the oxidation solution and left for 1 hour, stirring gently.

The oxidized pins are then rinsed in doubly distilled water and sonicated for 5 minutes.

The pins, once recovered, are placed in the solution of γ-APS and are left for 1 hour, stirring gently.

Then the pins that have been treated with γ-APS are annealed to permit reversal of the γ-APS molecule according to the reaction shown previously.

The aqueous phase is carefully withdrawn using a pipette without making contact with the steel pins then the vessel containing the pins is placed at 120° C. for 10 minutes.

The annealing step permits fixation of the γ-APS on the surface of the pins.

The pins are finally rinsed with doubly distilled water and stored at 50° C.

### EXAMPLE 2

Preparation of models for endovascular prostheses in phynox, cleaning, oxidation and amination of the surface

1) Support, Treatment Solutions and Silane Compounds Used

The support used consists of mirror-polished Phynox pins with a diameter of 10 mm and thickness of 4 mm supplied by the company Sofradim.

These pins serve as a model for the endovascular prostheses themselves in Phynox.

Phynox is a cobalt-based superalloy whose resistance to oxidation is far better than that of stainless steels.

Phynox meets the requirements of standards ASTM F-91 and ISO 5832/7 and NF S 94-057 relating to surgical implants.

The cleaning solutions are solutions of acetone and of hot ethanol.

The oxidizing solution is a sulfochromic mixture.

The silane compound is γ-APS (3aminopropyltriethoxysilane). This compound attaches itself to the hydroxyl functions of the surface and makes it possible to obtain the exposed amine functions.

2) Protocol

The Phynox pins are sonicated in acetone for 10 min then placed in a solution of ethanol at 70° C. for 10 min.

This step makes it possible to remove the surfactants used for cleaning.

A solution of γ-APS at 10% (v/v) in 950 ethanol is prepared and is stirred for 1 hour in order to hydrolyze the ethoxy functions and permit grafting on hydroxyl functions.

The oxidation solution is a sulfochromic solution at 2.7% (w/v) of potassium dichromate in 80% sulfuric acid.

At the same time, the cleaned steel pins are placed in the oxidation solution and left for 1 hour, stirring gently.

The oxidized pins are then rinsed in doubly distilled water, and sonicated for 5 minutes.

The pins, once recovered, are placed in the solution of γ-APS and left for 1 hour, stirring gently.

Then the pins treated with γ-APS are annealed to permit reversal of the γ-APS molecule according to the reaction shown previously.

The aqueous phase is carefully withdrawn using a pipette without making contact with the steel pins, then the vessel containing the pins is placed at 120° C. for 10 minutes.

This annealing step permits fixation of the γ-APS on the surface of the pins.

The pins are then rinsed with doubly distilled water and stored at 50° C.

### EXAMPLE 3

Preparation of metallic objects for endoprostheses with vapor-phase amination of the surface.

The system consists of two vessels separated by a tap. The vessel that is to receive the γ-APS is connected to a dropping funnel.

The metallic objects, previously submitted to oxidation as described in the protocols of examples 1 or 2, are placed in a vessel under slight pressure (8 mbar) and heated to 120° C. by a heating strip.

The γ-APS in solution at 10% v/v in pure ethanol is fed into the dropping funnel, then injected into one of the two vessels previously heated to 140° C. under a pressure of 8 mbar. The γ-APS is vaporized immediately.

The vessels are then brought into contact, under a pressure of 8 mbar, and the gaseous γ-APS is then brought into contact with the metallic object.

Grafting is immediate and is effected covalently since the annealing step is immediate, the metallic substrate being heated to a temperature of 120° C.

After reaction, the pressure is brought back to atmospheric pressure and the metallic object is rinsed with water.

XPS analyses effected on various metallic objects aminated in the vapor phase revealed a thin aminated layer on the entire surface of said objects.

### EXAMPLE 4

Analysis of the surface of the aminated pins.

1) Description of the Equipment

In order to verify the presence of an aminated coating on the surface of the pins, the latter were examined and their surfaces were characterized chemically.

The methods of analysis employed were XPS (X-Photoelectron Spectroscopy) and the AFM (Atomic Force Microscope).

2) Protocol

The XPS instrument used is an Escalab 210, using the Kα line of aluminum of energy 1486 eV under ultravacuum as the monochromatic source. This instrument analyzes an area of 3 mm² (3 mm×1 mm) to a depth of 10 nm.

The AFM is used in semi-contact mode on the surface of the steel pins.

3) Results

XPS analysis of the pins of stainless steel 316L revealed a homogeneous amination layer on the entire surface of the pin and with thickness greater than 10 nm. Said thickness was estimated at 30 nm. Free amine functions are exposed and thus permit subsequent grafting of dextran and/or of functionalized dextran derivatives. Analysis with the AFM showed accumulations of silane derivatives on the pins if silanization did not take place in 95° ethanol but in water. An identical analysis revealed a homogeneous amination layer on the surface of the pin analyzed.

### EXAMPLE 5

Test of cytotoxicity of the coating by “diffusion of extracts” assay.

1) Test, Cells, Controls and Specimens Used

The test used is a test of indirect measurement based on the toxicity of the products diffused or “released” by the modified pins. This test complies with international standard ISO 10 993-5, relating to the biological evaluation of medical devices.

The supports used are 24-well cell culture plates marketed by Corning Costar.

The cells used are immortalized human endothelial cells of the EAhy 926 line in the exponential growth phase seeded at 5000 cells/well.

The vehicle for extraction, as well as the negative control, is a culture medium at 10% (v/v) in fetal calf serum (FCS).

The positive control is a DMSO solution at 1% (v/v) in culture medium.

The specimens used are pins of stainless steel 316L: raw, oxidized and aminated by the methods described above.

2) Protocol

The steel pins are sterilized with 700 ethanol for 30 minutes then washed quickly with sterile PBS buffer. Then each one is placed at the bottom of a well of the cell culture plate and covered with 1.5 ml of culture medium with 10% FCS. The plates are then placed in an air/CO₂ incubator for 72 hours.

After incubation for 72 hours, the extracts are recovered and are brought into contact with EAhy 926 cells at the start of the exponential growth phase.

Cell density is estimated after 8 days of incubation by means of a cell counter (Coulter counter).

3) Results

Table 1 shows the various values for number of cells per well after eight days of incubation.

| | Oxidized | Aminated | Positive | Negative |
|---|---|---|---|---|
| Raw steel | steel | steel | control | control |
| 90 000 | 95 000 | 95 000 | 45 000 | 100 000 |

No cytotoxic effect was observed. No matter which treatment they underwent, the pins of steel 316L do not diffuse or do not “release” any toxic substance or substance that inhibits cellular proliferation.

### EXAMPLE 6

Grafting of a functionalized dextran derivative on aminated steel pins.

1) Metallic Support, Dextran and Coupling Agents Used

The metallic supports used are identical to those described in example 4.

The coupling agents used are EDAC and NHS, marketed by Sigma-Aldrich.

The functionalized dextran derivative used, with weight-average molecular weight of 70 000 g/mol, is DMC_{0.8}B_{0.22}Su_{0.11}; it corresponds to the general formula DMCₐB_{b}Su_{c}S_{d} as described previously.

Its preparation protocol is as described in the European patent published under the number 0146455. This functionalized dextran derivative inhibits the proliferation of smooth muscle cells, as shown in FIG. 2, but also inhibits the activation of complement (CH50 tests were carried out) and stimulates the proliferation of endothelial cells.

2) Protocol

A solution of DMCBSU, as described above, at 16% (w/v) is prepared in a buffer of MES 0.01 M, pH 3.5. The coupling agent EDAC is added at 13% (w/v) to the solution and stirred for 5 minutes. The second coupling agent NHS is added at 6% (w/v) and stirred for 30 minutes.

The steel pins are placed in 1 ml of phosphate buffer 0.1 M, pH 7.2, to which the solution described above is added. The pH is adjusted to 8.

The reaction continues for 24 hours then the pins are rinsed in doubly distilled water. The pins are then stored at 50° C. in a vacuum stove.

### EXAMPLE 7

Grafting of a functionalized dextran derivative on an aminated metallic surface.

The support, the coupling agents and the protocol are identical to those described in example 6.

As a difference from example 6, the functionalized dextran derivative used is DMC_{0.68}B_{0.34}Su_{0.12}; it corresponds to the general formula DMCₐB_{b}Su_{c}S_{d} as described previously.

Its preparation protocol is as described in the European patent published under the number 0146455. This functionalized dextran derivative inhibits the proliferation of endothelial cells of the EAhy 926 line.

### EXAMPLE 8

Grafting of a functionalized dextran derivative on an aminated metallic surface.

The support, the coupling agents and the protocol are identical to those described in example 6.

As a difference from example 6, the functionalized dextran derivative used is DMC_{0.6}B_{0.45}Su_{0.65} with weight-average molecular weight of 100 000 g/mol; it corresponds to the general formula DMCₐB_{b}Su_{c}S_{d} as described previously.

Its preparation protocol is as described in the European patent published under the number 0146455.

Its specific anticoagulant activity is 4.3 IU/mg in comparison with heparin, whose activity is 173 IU/mg. This compound is sterilized by filtration and lyophilization; it complies with the tests for sterility and apyrogenicity.

### EXAMPLE 9

Grafting of a functionalized dextran derivative on an aminated metallic surface.

The support, the coupling agents and the protocol are identical to those described in example 6.

As a difference from example 6, the functionalized dextran derivative used is DMC_{0.61}B_{0.39}Su_{0.23}; it corresponds to the general formula DMCₐB_{b}Su_{c}S_{d} as described previously.

Its preparation protocol is as described in the European patent published under the number 0146455.

Its specific anticoagulant activity is 3.5 IU/mg in comparison with heparin, whose activity is 173 IU/mg. This compound is sterilized by filtration and lyophilization; it complies with the tests for sterility and apyrogenicity.

### EXAMPLE 10

Test of adherence and of growth of endothelial cells on the modified pins of stainless steel 316L.

1) Test, Cells, Controls and Specimens Used

This test is a direct measurement of the adherence and proliferation of endothelial cells of the EAhy 926 line, described previously. This test complies with international standard ISO 10 993-5, relating to the biological evaluation of medical devices.

The supports used are pins of stainless steel 316L, on which surface modifications were carried out.

The control supports are wells of 24-well cell culture plates marketed by Corning Costar.

The culture medium used is culture medium with 10% (v/v) of fetal calf serum (FCS).

The pins used are raw pins, aminated pins and pins coated with the functionalized dextran derivative (DMC_{0.8}B_{0.22}Su_{0.11}) described previously.

2) Protocol

The DMCBSu is grafted on pins of stainless steel 316L.

8 pins are prepared for carrying out measurements of cellular adherence and for evaluating their growth as a function of the support. 8 control pins are added to the test as well as 8 blank wells of sterile 24-well plates from Corning Costar.

The grafted pins and the raw pins are sterilized at the bottom of the wells for 40 min in 70° ethanol. They are then rinsed twice with sterile PBS then conditioned with the culture medium (10% of FCS) for 3 days.

The cells are seeded at 25 000 cells per well per pin.

Two pins are taken and analyzed at 24 h, 48 h, 72 h and 7 days.

The analysis is carried out as previously, by detaching the cells adhering to the pins and counting with the Coulter counter.

3) Results

The test results are shown in Table 2. The results have been converted to number of cells per cm². The area of a face of a pin of stainless steel 316L is equal to one quarter of that of the bottom of a well (2 cm²). It was considered that the cells would adhere, initially, twice as much on the pin as on the well, since they had been deposited on the pin then immersed in the medium.

There is better adherence of the cells on the grafted pins than on the raw pins.

These results indicate that grafting is effective and that DMC_{0.8}B_{0.22}Su_{0.11} exerts an action even though it is immobilized on a surface.

Identical results are obtained with the compound DMC_{0.6}B_{0.45}Su_{0.65} previously described.

TABLE 2
Number of cells per cm² as a function of time
and surface

| | Grafted | Control | Control |
|---|---|---|---|
| | pins | pins | wells |
| 24 hours | 17127 | 9500 | 3878 |
| 48 hours | 20047 | 13470 | 6233 |
| 72 hours | 28840 | 15540 | 11072 |
| Tt0 | 25000 | 25000 | 12500 |

### EXAMPLE 11

Example of test of adherence of endothelial cells on modified pins of stainless steel 316L

The principal agents of this biological test are identical to those in example 10. As a departure from example 10, the functionalized dextran derivative is DMC_{0.68}B_{0.34}Su_{0.12}.

The cells were sown at a density of 75 000 cells per well per pin. A single measurement was carried out after 5 days of incubation.

The results are shown in Table 3.

TABLE 3
Number of cells per cm² after 5 days of
incubation on the pins

| | (Cells)/cm² |
|---|---|
| Control wells | 148160 |
| Oxidized pin | 122000 |
| Aminated pin | 118500 |
| Raw pin | 120040 |
| Grafted pin | 65760 |
| Wells of raw pins | 127410 |
| Wells of grafted pins | 139860 |

The various intermediate pins have very little influence on the adherence of the endothelial cells. However, the functionalized dextran derivative grafted onto the surface of the pin inhibits adherence of the EAhy 926 cells.

These results confirm the effectiveness of grafting by the method described in this document.

Furthermore, functionalized dextran derivatives have effects on activation of complement and on platelet activation, which are the object of measurements.

### EXAMPLE 12

Example of test of adherence of endothelial cells and of smooth muscle cells on modified pins of stainless steel 316L

The principal agents of this biological test are identical to those in example 10. As a departure from example 10, the functionalized dextran derivative is DMC_{0.6}B_{0.45}Su_{0.65}.

The cells were sown at a density of 10 000 endothelial cells per well per pin and 15 000 smooth muscle cells per well per pin.

A single measurement was carried out after 5 days of incubation.

The results are shown in Table 4.

TABLE 4
Number of cells after 5 days of incubation on
the pins

| | Endothelial | |
|---|---|---|
| | cells | CML |
| Raw pin | 5 000 | 315 000 |
| Oxidized pin | 4 800 | 300 000 |
| Aminated pin | 48 800 | 160 000 |
| Grafted pin | 51 000 | 87 500 |

Stimulation of growth of the endothelial cells and inhibition of growth of the smooth muscle cells were observed. These results were obtained both on the aminated pins and on the grafted pins, therefore the aminated coating also has an effect as such.

### EXAMPLE 13

Preparation of endovascular prostheses according to the present invention, cleaning, oxidation, amination of the surface and grafting of functionalized dextran derivatives.

The support used consists of balloon-expandable stents in stainless steel 316L supplied by the company Sofradim. Stainless steel 316L is a type 18/12 (chromium/nickel content) austenitic steel with CFC structure, complying with European standards NF S 90 401, NF S 90 402, NF S 90 403 and NF S 94 051.

The cleaning solutions are solutions of acetone and of hot ethanol.

The oxidizing solution is a sulfochromic mixture.

The silane derivative is γ-APS (3-aminopropyltriethoxysilane). This compound attaches itself to the hydroxyl functions of the surface and makes it possible to obtain exposed amine functions.

The functionalized dextran derivatives used are: DMC_{0.8}B_{0.22}Su_{0.11}, DMC_{0.6}B_{0.45}Su_{0.65}, DMC_{0.68}B_{0.34}Su_{0.12}, DMC_{0.61}B_{0.39}Su_{0.23}, described previously.

2) Protocol

The stents of stainless steel 316L are sonicated in acetone for 10 min then placed in a solution of ethanol at 70° C. for 10 min. This step permits elimination of the traces of surfactant that might still be on the surface following cleaning.

A solution of γ-APS at 10% (v/v) in 95° ethanol is prepared and stirred for 1 hour in order to hydrolyze the ethoxy functions and permit grafting on hydroxyl functions.

The oxidation solution is a sulfochromic solution at 2.7% (w/v) of potassium dichromate in 80% sulfuric acid.

At the same time, the cleaned steel stents are placed in the oxidation solution and left for 1 hour, with gentle stirring. The oxidized stents are then rinsed in doubly distilled water, with sonication for 5 minutes. The stents thus recovered are then placed in the solution of silane derivatives and left for 1 hour, stirring gently.

The stents treated with γ-APS are then annealed to permit reversal of the γ-APS molecule according to the reaction shown previously. The aqueous phase is carefully withdrawn using a pipette without making contact with the steel stents then the vessel containing the stents is placed at 120° C. for 10 minutes. The stents are then rinsed with doubly distilled water.

Solutions of DMCBSu, such as those described above, at 16% (w/v) are prepared in a buffer of MES 0.01 M, pH 3.5. The coupling agent EDAC is added at 13% (w/v) to the solution and stirred for 5 minutes. The second coupling agent NHS is added at 6% (w/v) and stirred for 30 minutes.

The stents are placed in 1 mL of phosphate buffer 0.1M, pH 7.2, to which the solution described above is added.

The pH is adjusted to 8.

The reaction is left to proceed for 24 hours then the stents are rinsed with doubly distilled water. The stents are then stored at 50° C. in a vacuum stove.

This grafting step can be carried out several times for improving the thickness of the active layer.

XPS analyses of the surfaces and examination with the scanning electron microscope (SEM) revealed, on all the surfaces, a homogeneous covering of γ-APS with thickness greater than 10 nm as well as the uniform presence of chemical groups that are characteristic of the functionalized dextran derivatives used.

1. A method of coating and bonding the surface of a metallic substrate with a layer of a polysaccharide compound, characterized in that, on the basis of the metallic substrate:
(a) we have an agent for chemical modification of the surface of the metallic substrate, for example in liquid form;
(b) we have an agent for intermediate covering, comprising a silane compound, in solution for example, containing two reactive residues, one with the metallic substrate, and the other, directly or indirectly, with the polysaccharide compound, said silane compound containing one or more amine groups or derivatives of amines and one or more hydroxyl or alkoxy groups;
(c) we have a coating agent, containing, in solution for example, the polysaccharide compound;
and the following operations are carried out:
(1) the surface of the metallic substrate is brought into contact with the agent for chemical modification, to obtain a chemically modified surface;
(2) the chemically modified surface is brought into contact with the intermediate covering agent, to obtain a surface coated with an intermediate layer comprising the silane compound, bound covalently to the metallic substrate;
(3) the metallic substrate whose surface is coated with the intermediate layer is annealed, before being brought into contact with the coating agent;
(4) the intermediate layer is brought into contact with the coating agent, to coat said intermediate layer with a coating comprising the polysaccharide compound bound covalently, directly or indirectly, to the silane compound.

2. The method as claimed in claim 1, characterized in that the chemically modified surface is cleaned before being brought into contact with the intermediate covering agent, for example with a solution of acetone, or of alcohol, and/or of surfactants.

3. The method as claimed in claim 1, characterized in that annealing is carried out at a temperature between 80 and 140° C. approximately, and/or for a time between 1 and 30 minutes approximately.

4. The method as claimed in claim 1, characterized in that the surface coated with the intermediate layer is washed, before being brought into contact with the coating agent.

5. The method as claimed in claim 1, characterized in that the surface coated with the polysaccharide compound is washed.

6. The method as claimed in claim 1, characterized in that operation (1) and/or (2) is carried out in the liquid or vapor phase.

7. The method as claimed in claim 1, characterized in that operation (2) is carried out in the liquid phase, at a pH between 2 and 9, and/or at a temperature between 25 and 120° C., and/or for a time between 1 and 120 minutes.

8. The method as claimed in claim 1, characterized in that operation (2) is carried out in the vapor phase, at a temperature above 120° C. and at a pressure greater than 4 mbar.

9. The method as claimed in claim 1, characterized in that the agent for chemical modification, in the liquid form, contains at least one strong inorganic acid, for example sulfuric, hydrochloric or nitric acid, and at least one oxide of chromium.

10. The method as claimed in claim 9, characterized in that the strong inorganic acid is present in the agent for chemical modification, in the liquid form, in a proportion between 5 and 100% (v/v).

11. The method as claimed in claim 9, characterized in that the oxide or oxides of chromium are present in the agent for chemical modification, in the liquid form, in a proportion between 1 and 40% (w/v).

12. The method as claimed in claim 9, characterized in that the oxide of chromium has an average molecular weight between 50 and 500 g/mol, and is for example selected from the group comprising the potassium dichromates and the chromium (IV) oxides.

13. The method as claimed in claim 9, characterized in that the pH of the agent for chemical modification, in the liquid form, is between 1 and 6.

14. The method as claimed in claim 1, characterized in that the intermediate covering agent, in the liquid state, contains at most 50%, and preferably between 1 and 30% (v/v) of the silane compound.

15. The method as claimed in claim 1, characterized in that the silane compound has an average molecular weight between 50 and 500 g/mol.

16. The method as claimed in claim 1, characterized in that the silane compound is selected from the group comprising the aminopropylsilanes and the aminobutylsilanes.

17. The method as claimed in claim 1, characterized in that the coating agent, in the liquid state, contains between 1 and 20% (w/v) of the polysaccharide compound, in solution.

18. The method as claimed in claim 1, characterized in that the coating agent contains an unmodified or unfunctionalized polysaccharide, for example a dextran, and/or a functionalized polysaccharide derivative that can be obtained from a polysaccharide, for example a dextran.

19. The method as claimed in claim 18, characterized in that the polysaccharide is a dextran having an average molecular weight between 20 000 and 1 000 000 g/mol, for example having a molecular weight equal to 40 000 or 70 000, or 460 000 g/mol.

20. The method as claimed in claim 1, characterized in that the coating agent contains at least one coupling agent, for example selected from the group comprising bis-sulfo (succinimide-suberate) abbreviated to BS3, dimethyladipimidate abbreviated to DMA, epoxirane, bis-epoxirane, succinimides, epichlorohydrin, carbodiimides.

21. The method as claimed in claim 20, characterized in that the coupling agent is 1-ethyl-3-3-(dimethylaminopropyl)-carbodiimide, abbreviated to EDAC, or N-hydroxysuccinimide, abbreviated to NHS.

22. The method as claimed in claim 21, characterized in that the coupling agent is present, in the coating agent, in a proportion from 20 to 50 mol per 100 mol of the oside unit of the polysaccharide chain.

23. The method as claimed in claim 18, characterized in that the coating agent contains an additional polysaccharide, natural or synthetic, substituted by carboxylate and/or sulfate functions, said additional polysaccharide being different from said functionalized polysaccharide derivative.

24. A coated metallic substrate, obtainable by a method as claimed in claim 1.

25. An endovascular prosthesis, of the stent type, comprising a coated metallic substrate as claimed in claim 24.

26. The endovascular prosthesis as claimed in claim 25, characterized in that the metallic substrate is an alloy, for example a stainless steel, or a superalloy, for example Phynox.

27. A metallic object for medical or surgical use, of the prosthesis type, for example endovascular prosthesis (called “stent”) for percutaneous transluminal coronary angioplasty, comprising a metallic substrate whose surface is coated at least partly with a polysaccharide compound, characterized in that the polysaccharide compound is bound covalently to the metallic substrate, via linkages, each one comprising at least one silane unit, bound on the one hand to the metallic substrate by a metal-O— bond, and on the other hand, directly or indirectly, by a covalent-NH— bond, to the polysaccharide compound.

28. The object as claimed in claim 27, characterized in that the polyose chain of the polysaccharide compound is that of a polysaccharide selected from the group comprising starch, glycogen, celluloses, dextrans, poly-β-1,3-glucans, poly-β-1,6-glucans, pullulans, chitin, chitosan, arabans, xylans, fucans, and pectins.

29. The object as claimed in claim 27, characterized in that the polyose chain of the polysaccharide compound is that of a dextran with a molecular weight greater than about 5000 g/mol, and contains a multiplicity of α-D-glucopyranose units joined together by α (1-6) linkages.

30. The object as claimed in claim 27, characterized in that the polysaccharide compound is a functionalized polysaccharide derivative, i.e. in which at least a proportion of the oside units is substituted with respect to the free hydroxyl functions of each oside unit, by one or more constituents, each of which is selected from the group comprising the methylcarboxylates, the carboxymethylbenzyl amides, the sulfates, and the sulfonates, including carboxymethylsulfonates.

31. The object as claimed in claim 30, characterized in that the polysaccharide compounds will be selected from the compounds of general formula DMC₂BbSucSd in which:
D represents a polysaccharide chain, consisting of arrangements of α-D-glucopyranose units joined together by α (1-6) bonds,
MC represents methylcarboxylate groups,
B represents carboxymethylbenzylamide groups,
Su represents sulfate groups,
S represents sulfonate groups, and
a, b, c and d represent the degree of substitution (ds), expressed relative to the number of free hydroxyl functions in one glucoside unit of the dextran, respectively in groupings MC, B, Su and S, a being equal to 0 or ≧0.2, b being equal to 0 or ≧0.1, c being equal to 0 or ≧0.1 and d being equal to 0 or ≦0.15, provided that when d=0, a and/or b are # 0.

32. The object as claimed in claim 31, characterized in that the polysaccharide compounds will be selected from the group comprising:
functionalized dextrans in which a≧0.7 0.15≦b≦0.3, 0≦c≦0.15 and d=0 or ≦0.1 and whose weight-average molecular weight is between 5000 and 200 000 g/mol,
functionalized dextrans in which 0.4≦a≦0.8, 0.3≦b≦0.8, 0.1≦c≦0.9 and d=0 or ≦0.1 and whose weight-average molecular weight is between 5000 and 200 000 g/mol,
functionalized dextrans in which a≧0.5 0.3≦b≦0.5, c=0 or ≦0.1 and d=0 or ≦0.1 and whose weight-average molecular weight is between 5000 and 200 000 g/mol.

33. The object as claimed in claim 27, characterized in that the polyose chain of the polysaccharide compound is that of a dextran, with a molecular weight greater than about 5000 g/mol, made up of oside units A, B and C, the units A being dextran units, and the oside units comprising, randomly:
at least approx. 35% of units B made up of oside units A substituted by radicals possessing a carboxyl function corresponding to the structure —O—(CH₂)ₙ—R—COO⁻ in which R represents a single bond or a group —CO—NH—(CH₂)_{n′}⁻, n being a number between 1 and 10 and n′ being between 1 and 7.
at least approx. 3% of units D, i.e. of oside units A substituted by a chain containing a group with the structure: 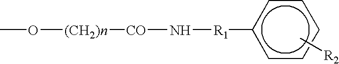
in which n is defined above, R₂ represents an anion of a physiologically acceptable inorganic or organic salt, and R₁ represents a single bond, a group —CH₂— or a group: 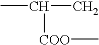
possibly, unsubstituted oside units A and/or units C consisting of units A substituted by radicals with the following structure, in which R₁ and n are as defined above:

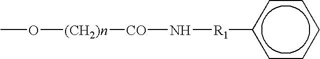

34. The object as claimed in claim 27, characterized in that the polyose chain of the polysaccharide compound is that of a dextran, and contains a multiplicity of polysaccharide compound units that can be selected from the derivatives of dextrans, possessing a molecular weight greater than about 5000 g/mol, made up randomly of units A, B and C and comprising units A and C and at least 35% of units B,
the units A being oside units of dextrans,
the units B being constituted of oside units A substituted by radicals possessing a carboxyl function corresponding to the structure —O—(CH₂)ₙ—R—COO— in which R represents a single bond or a group —CO—NH—(CH₂)_{n′}⁻, n being a number between 1 and 10 and n′ being between 1 and 7 and the units C being constituted of units A substituted by radicals with the following structure, 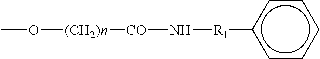
in which R₁ represents a single bond, a group —CH₂— or a group: 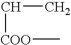
n is a number between 1 and 10.

35. The object as claimed in claim 27, characterized in that the polysaccharide compound is a natural or synthetic polysaccharide, unmodified, and in particular unfunctionalized.
